(19) United States
(12) Patent Application Publication
(10) Pub. No.: US 2003/0123172 A1
(43) Pub. Date: Jul. 3, 2003

(54) System and method for efficient media certification during servowriting

(76) Inventors: Jun Zhu, Palo Alto, CA (US); Alex Moraru, Aptos, CA (US); Douglas Peale, Fremont, CA (US)

Correspondence Address: Steven W. Smyrski, Esq., Smyrski & Livesay, LLP, 3310 Airport Avenue, SW, Santa Monica, CA, 90405-6118, US

(21) Appl. No.: 10/307,212

(22) Filed: Nov. 29, 2002

Related U.S. Application Data
(60) Provisional application No. 60/335,232, filed on Nov. 30, 2001.

(51) Int. Cl. G11B 27/36; G11B 21/02

(52) U.S. Cl. 360/31; 360/75

(57) ABSTRACT

A system and method for performing a combined media certification and servo data writing function is disclosed. The system and method include mounting a plurality of media, such as hard disks, to a spindle and using at least one positioner to move multiple read write heads over disk surfaces according to multiple specific aspects of the invention. One aspect of the invention comprises performing certification on a first pass, writing servo pattern data on a second pass, and verifying servo data on a third pass over the media. The system may require high performance read/write heads, writing of coherent patterns in addition to servo patterns, use of multiple positioners, and additional hardware to perform the joint certification and servowriting function.

This application claims the benefit of U.S. Provisional Patent Application Serial No. 60/335,232, filed Nov. 30, 2001.

### BACKGROUND OF THE INVENTION

1. Field of the Invention

The present invention relates generally to the field of computer media, and more specifically to efficiently performing certification of media, such as a hard disk, in connection with the media servowriting function.

2. Description of the Related Art

Computer media such as Hard Disk Drives (HDDs) produced in any type of environment may have defects located thereon, particularly on the surface of disks employed in such drives. Dust particles, surface defects, or other anomalies tend to inhibit disk drive performance, and may cause certain sectors to be unavailable to the user. Disk drives currently produced employ a certification scheme wherein data is written to the disk and the disk is examined for variations in the expected written pattern or data. This certification procedure usually occurs before the disks have been installed in the disk drive. After the disks have been installed in the disk drive, the drive is then assembled, and the servowriting procedure is done in the drive. The existence of significant defects can require removing the disk from the assembly and replacing the disk with a new one.

A problem with the typical current certification arrangement is one of throughput. Procedures such as certification occur prior to servowriting. Once an HDD is assembled, servo data is written to each disk, then servo patterns verified on each disk. If the disk is faulty, it may be rejected. Thus each disk normally requires time for at least two complete write procedures and at least one read procedure. For large production of hundreds or even thousands of disk drives, the time required to certify each disk and perform other verification and initialization tasks can be quite significant.

It would be beneficial if the time required to certify the disk surface could be decreased, or throughput of HDD production improved while at the same time providing a high level of confidence in the surface integrity of the media.

### SUMMARY OF THE INVENTION

The present invention is a system and method for performing certification during servowriting of media, such as a hard disk or at least doing both servowriting and certifying sequentially on the same machine. The present system and method perform certification and servowriting and verification in an efficient manner, combining functionality and preferably performing such tests on multiple media to increase throughput.

The present invention includes performing a joint certification and servowriting function on a plurality of media, including writing a certification and servo pattern to a plurality of disks. The certification and servo pattern may differ according to particular aspects of the invention, in both content and the ordering thereof. The information written includes servo data at a minimum, and may include additional information such as a coherent pattern written to the surface of the disk. Following writing the information, the system reads the information to ascertain system performance, typically parametric and/or defect parameters and/or servo parameters. One aspect of the current invention is to write certification data to all disks, then writing servo data on a second pass and verifying servo data on a third pass. This ordering may be altered according to specific aspects of the current invention.

The system comprises a stack of media mounted on a spindle, such as an air bearing spindle, and employing at least one and possibly two or more positioners to move all the heads to servowrite the disk stack. The heads employed may be traditional read/write heads or, in certain circumstances, custom write heads to perform spiral writing. According to the current invention, the system can employ multiple positioners, additional computational hardware, and other hardware to effectuate efficient certification and servowriting.

According to a first aspect of the current invention, the system performs certification and subsequently performs servo writing. Certification occurs as a first step on all disks at one time, in a step and repeat format. This procedure is repeated sequentially, stepping through the tracks to test the disk surface. According to a second aspect of the current invention, certification occurs using a spiral machine in conjunction with a servowriter system. The first pass consists of certification, the second pass writes servo data, and the third pass verifies the servo data. Use of a spiral machine, as opposed to a step and repeat machine enables all heads to be certified in parallel. When using spiral machine servowriting, the system employs a head having a wider than normal write gap that is mounted on one positioner and is continuously writing a signal to the disk. A head with a nominal read gap is mounted to a second positioner and continuously tracks and reads the signal written by the write head. Both positioners move continuously, the read positioner slightly lagging the write positioner such that the read head is always on the spiral track written by the write head. According to a third aspect of the current invention, the system writes a coherent pattern in each zone of the disk. The system writes the coherent pattern on the first pass, certifies the coherent pattern data on a second pass, writes servo data on a third pass, and verifies servo data on the fourth pass. The fourth aspect of the current invention is performing certification on a servowritten preamble of a servo pattern. Each servo section, or wedge, contains a preamble section. In this aspect of the current invention, the system first servowrites the entire disk. The second pass verifies this servo data as well as certifying the coherent pattern of the preamble section of the servo pattern.

According to a fifth aspect of the current invention, write heads attached to the positioner write a coherent pattern in the data area while simultaneously servo writing. This system certifies the data areas during the servo pattern verification. The system performs a first pass including servo writing and coherent pattern writing, and a second pass reading servo data and of the coherent pattern. According to a sixth aspect of the current invention, the system skews each servo burst relative to all other disk surfaces whose servo data are controlled by a multi-channel preamp in a multi disk arrangement. This skewing separates the servo patterns in time such that only a single servo pattern is being read from any disk at any one time from multiple disks controlled by the same preamp during operation. Use of this skewing arrangement enables use of a single servo verification circuit per preamp to certify surfaces using a single revolution. Thus the system performs two passes in this sixth aspect of the invention, a first pass over all surfaces to write servo data in a skewed pattern, and a second pass to verify servo data and certify the disk surface. According to a seventh aspect of the current invention, the system writes multiple sets of servo data sections over the entire surface of the disk. The disk drive is then used to verify the servo patterns and selects the best servo pattern from those available. During formatting of the hard drive, the drive overwrites all unfavorable servo wedges. In this manner, servo verification occurs in the actual hard drive being used.

These and other objects and advantages of the present invention will become apparent to those skilled in the art from the following detailed description of the invention and the accompanying drawings.

### DESCRIPTION OF THE DRAWINGS

FIG. 1 is a general conceptual representation of the certification and servowriting system disclosed herein;

FIG. 2 illustrates the concept of servowriting as applied to media, such as a single hard disk;

FIG. 3 is the multiple disk and spindle arrangement used to perform the combined certification and servowriting function;

FIG. 4 presents the single multiple read/write head positioner arrangement utilized in the current invention;

FIG. 5 illustrates the various blocks of the first aspect of the current system;

FIG. 6 shows a coherent pattern written on media;

FIG. 7a represents the mechanics of the certification and servo writing device of the current invention;

FIG. 7b presents an alternate view of the certification and servowriting device with media cover and in-place positioner;

FIG. 8 illustrates the various blocks of the second aspect of the current system;

FIG. 9 shows the various blocks of the third aspect of the current system;

FIG. 10 presents the various blocks of the fourth aspect of the current system;

FIG. 11 represents the various blocks of the fifth aspect of the current system; and

FIG. 12 shows the various blocks of the sixth aspect of the current system; and

FIG. 13 illustrates the various blocks of the seventh aspect of the present invention.

### DETAILED DESCRIPTION OF THE INVENTION

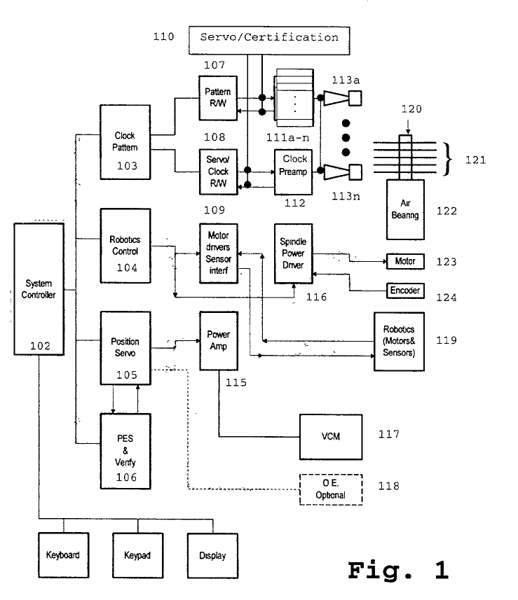

FIG. 1 is a general conceptual representation of the current joint certification and servowriting system. From FIG. 1, the system controller 102 controls clock pattern 103, robotics control 104, position servo 105, and PES and verify block 106. Robotics control 104, position servo 105, and PES and verify blocked 106 perform functions related to present invention. For example, robotics control 104 provides commands to drive the motors and sensors interacting with the spindle and air bearing to drive the multidisk spindle and air bearing arrangement.

Clock pattern circuit 104 generates a clocking signal and establishes the pattern generated on the disk surface. System controller 102 provides an indication to clock pattern circuit 104 to initiate a pattern on the disk surface when appropriate, such as during disk processing routines when it is appropriate for certification and servowriting to occur. Pattern read/write block 108 provides signals for reading and writing the pattern established by the clock pattern circuit 104. This pattern is the pattern used for this certification as described herein, which is written to and read from the media. Clock pattern circuit 104 also issues commands for servo/clock writing to servo clock circuit 109. Servo clock circuit 109 writes servo clock information to the disk and reads that clocking information to assess the validity of the servo data. Servo/certification module 110 determines the proper time, data, and pattern for servowriting for the multiple head/multiple disk arrangement of the present invention. Operation of servo/certification module is described below. Servo certification module 110 receives data from pattern read/write block 108 and servo/clock read/write circuit 109 and transmits appropriate data and receives relevant data at multiple data preamps 111a through 111n, where n is the total number of preamps used to write to multiple disk. For example, but not limitation, a system may employ ten disks and twenty heads in connection with four preamps. Uniform correspondence in preamp to disk ratio between data preamps is not required, and one data preamp may write to one disk while another may write to several media disks in the same configuration. Multiple data preamp and disk arrangements may be employed while still within the course and scope of the present invention. Servo/clock read/write circuit 109 also transmits and receives relevant data at clock preamp 112. These preamps filter and amplify data received from the various circuits and transmit the amplified signals to the appropriate read/write heads 113a-n.

In the present invention, disks are located on spindle 114 and read/write heads 113a-n positioned proximate the disk surface using the head stack assembly. The spindle preferably rides on an air bearing 115, thereby operating to rotate the disks in an efficient manner while multiple heads engage the media 116, such as multiple hard disks 116a-n, in order to read and write appropriate information. The system writes patterns, including servo patterns, to each disk using the read/write heads. As reading and writing using multiple heads requires a great deal of simultaneous processing, reduced processing requirements and time sharing results in significant cost savings. The system writes servo data and performs certification in a timely and cost effective manner using the spindle 114 and head stack assembly arrangement.

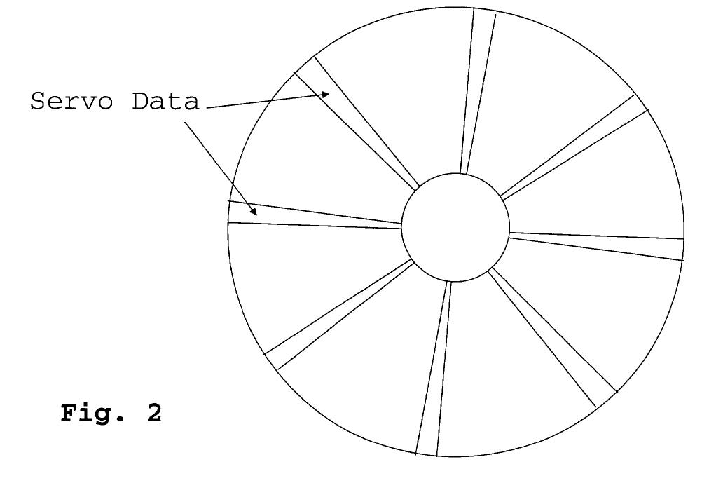

FIG. 2 illustrates the concept of servowriting as it is applied to media, such as a single hard disk. As shown in FIG. 2, the system writes servo data at radial positions around the media disk surface. Servo data provides reference data for accurate positioning of the disk during reading and writing operations, and every disk generally includes servo data.

Certification testing typically consists of parametric testing such as track averaged amplitude, signal to noise, overwrite, and defect testing. Defect testing may include thermal asperity, missing pulses, extra pulses, and modulation testing. These testing methods require writing certain information to a disk surface in a predetermined manner and reading that information back from the disk. The certification information is typically written to the disk and remains on the disk, and does not affect subsequent disk performance. Depending on the type of test being performed and the parameters being tested, different data is written and read from the disk to certify performance of the disk, including the validity of individual tracks.

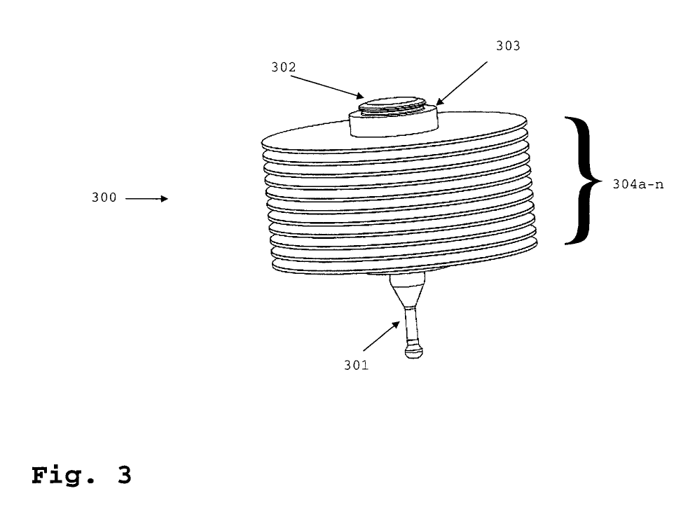

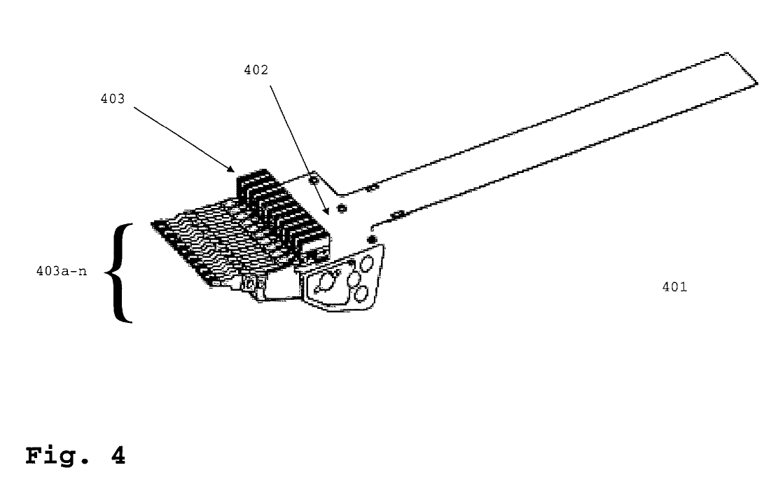

FIGS. 3 and 4 present the multiple media arrangement and multiple head positioner arrangement used in connection with the current servowriter invention. From FIG. 3, loaded media chuck with media 300 includes cap 302, locking mechanism 303, disks 304a-n, and rotation element 301. Any number of media disks may be employed, and the arrangement of FIG. 3 illustrates 10 media disks. FIG. 4 represents the positioner with servo heads loaded thereon that are located proximate the loaded chuck with media 300 to read from and write to the disks. Positioner element 400 includes head clips 401, flexible preamp 402, and servo heads and associated positioner arms 403a-n, which in the arrangement shown comprise ten such devices.

The present system has the ability to operate in a variety of different aspects. In a first aspect, the system performs certification and subsequently performs servo writing. Certification occurs as a first step on all disks at one time, in a step and repeat format. Step and repeat, as used herein, means the sequence of moving the read/write head to a track, writing one full revolution of data, moving the read gap of the head over the track written by the write gap of the head and reading back the written data. This procedure is repeated sequentially, stepping through the tracks to test the disk surface. In this first aspect, certification is performed by stepping through the read and write certification process for the disk and repeating over the surface of the disk.

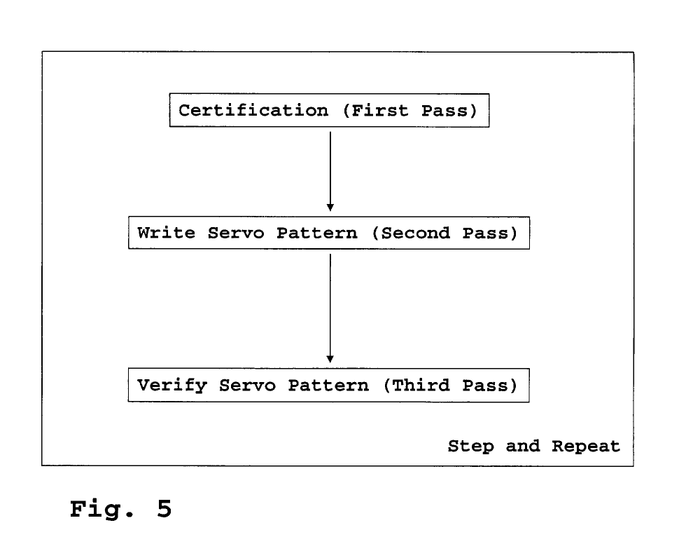

Using the write heads and electronics arrangement shown in FIGS. 3 and 4, a single head can be used to certify a disk during a given time period, and multiple disks cannot be certified at once. Thus, the system sequentially steps through each head to certify each disk serially. No parallel certification occurs. Subsequent to this serial certification, the system writes the servo pattern on the second pass and verifies the servo pattern on the third pass. This aspect of the invention employs a typical read/write head, and commonly available certification hardware. Heads are repositioned during reading and writing of certification data to certify the tracks due to the physical read and write differences associated with traditional read/write heads. This aspect of the current invention requires three passes of the heads over the media. FIG. 5 illustrates the various blocks of this first aspect of the current system.

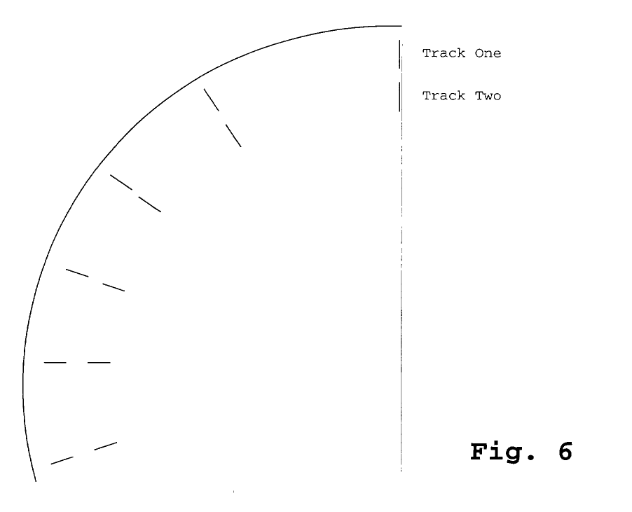

An alternative to this first aspect of the invention is to write a coherent pattern to each zone of the desk. A coherent pattern is illustrated in FIG. 6. As shown in FIG. 6, a coherent pattern consists of overlapping tracks written with the same pattern in the same phase over substantially the entire surface of the media to effectively achieve a written track much wider than the width of the standard write head. Coherent pattern writing enables the read head to read the pattern accurately without being accurately positioned over a narrow written track. According to this first aspect of the invention employing a coherent pattern, certification comprises a writing phase, wherein data is written in a coherent pattern, followed by a certification reading phase. The servo pattern is then written followed by servo data verification reading.

According to a second aspect of the current invention, certification occurs using a spiral machine in conjunction with a servowriter system. The first pass comprises certification, the second pass writes servo data, and the third pass verifies the servo data. Use of a spiral machine, as opposed to a step and repeat machine, enables all heads to be certified in parallel. Using spiral machine servowriting, the system employs a head having a wider than normal write gap that is mounted on one positioner and is continuously writing a signal to the disk. A head with a nominal read gap is mounted on a second positioner and continuously tracks and reads the signal written by the write head. Both positioners may move continuously, the read positioner slightly lagging the write positioner such that the read head is generally on the spiral track written by the write head. The system requires three passes of the heads over the media, and custom wide right heads must be employed to read that track accurately. Such wide write heads are generally available but are used primarily for specialty applications.

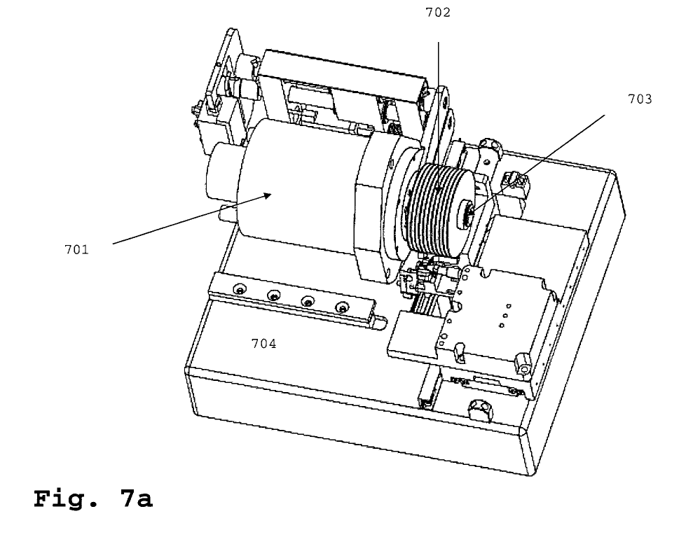

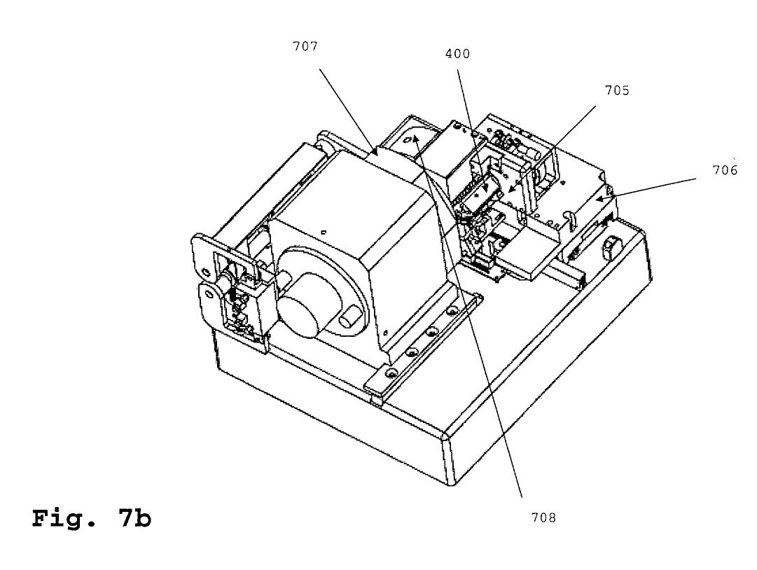

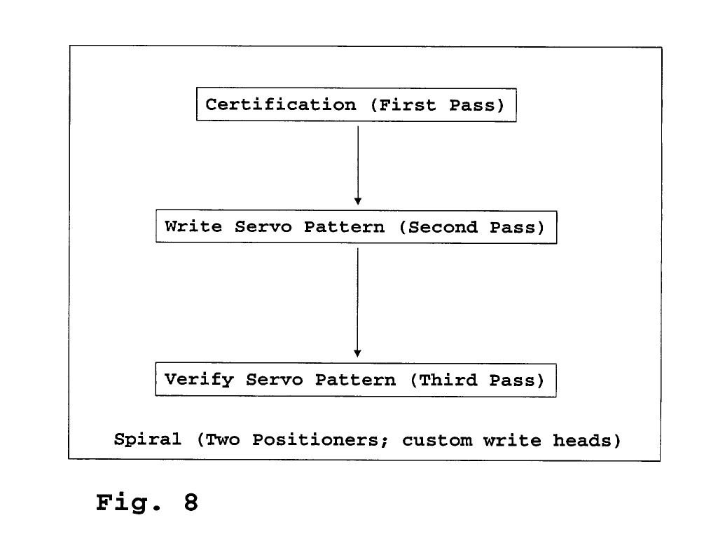

A representation of the mechanics of the servowriter machine is presented in FIGS. 7a and 7b. From FIG. 7a, spindle with disk chuck 701 houses the hardware used to spin media disks 702 loaded on the removable chuck 703. FIG. 7b is an alternate view of the device including media cover, or shroud, and media reading assembly. Spindle with disk chuck 701 is mounted to base 704. From FIG. 7b, spindle 707 rotates the media disks (not shown) that are enclosed in shroud 708. VCM 705 interacts with VCM slide 706 and positioner element 400 to read from and write to the media disks. An alternate design of this system applicable to the current aspect is the use of a second positioner assembly, similar to that illustrated in FIG. 4, including a read head having nominal read gaps, wherein the read head substantially continuously tracks and reads the signal written by the write head affixed to the first positioner. Both the first positioner and second positioner move substantially continuously, with the second positioner slightly lagging the first positioner such that the read head is generally over the spiral track written by the write head. The two positioners each have ten heads in such an orientation. FIG. 8 illustrates the various blocks of this second aspect of the current system.

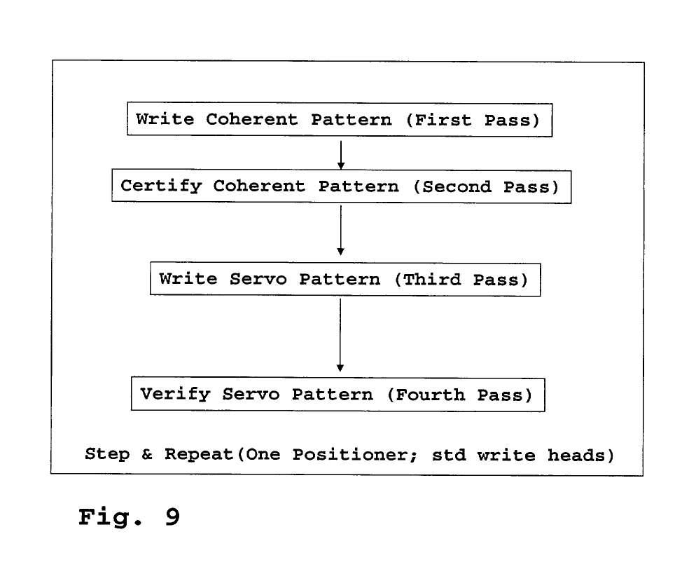

According to a third aspect of the current invention, the system writes a coherent pattern in each zone of the disk. The system writes the coherent pattern on the first pass, certifies the coherent pattern data on a second pass, writes servo data on a third pass, and verifies servo data on the fourth pass. A single positioner is employed and all heads can certify data in parallel. Certification may be performed by a spiral pattern or by a step and repeat function. FIG. 9 illustrates the various blocks of this third aspect of the current system.

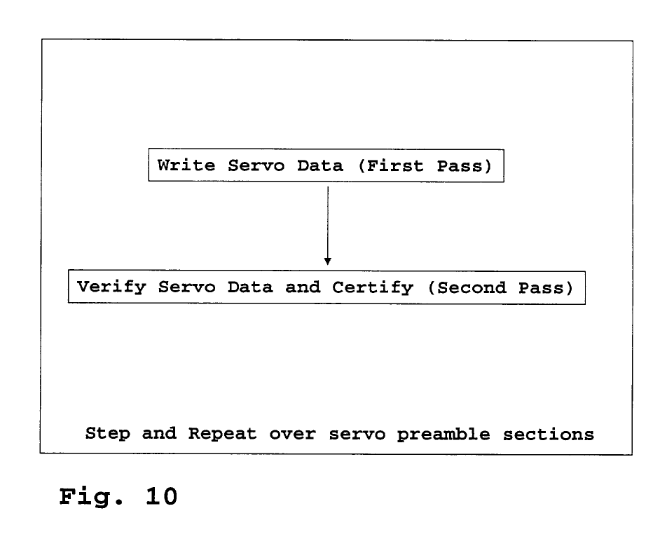

The fourth aspect of the current invention is performing certification on a servowritten preamble of a servo pattern. Each servo wedge contains a preamble section. In this aspect of the current invention, the system first servowrites the entire disk. The second pass verifies this servo data as well as certifying the coherent pattern of the preamble section of the servo pattern. Certification is therefore performed on a preselected subsection of the entire disk, but this aspect employs a single positioner and requires a single read channel, assuming servo patterns are skewed between disks. This aspect further requires only two passes of the heads over the media. FIG. 10 illustrates the various blocks of this fourth aspect of the current system.

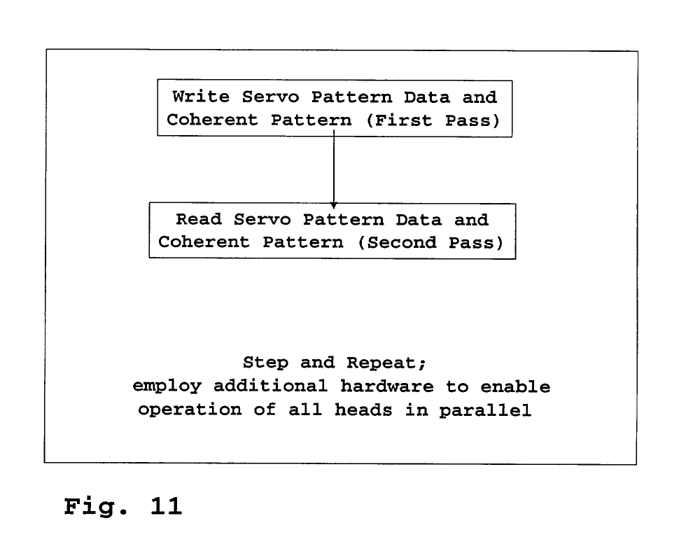

According to a fifth aspect of the current invention, write heads attached to the positioner write a coherent pattern in the data area while simultaneously servo writing. This system certifies the data areas during the servo pattern verification. The system performs a first pass including servo writing and coherent pattern writing, and a second pass reading servo data and the coherent pattern. This aspect of the current invention tests the data area of the disk and is performed by all heads operating in parallel. If this system tests all heads in parallel, further processing hardware may be required beyond that normally employed, or track verification must occur sequentially over the entire surface, requiring more time. FIG. 11 illustrates the various blocks of this fifth aspect of the current system.

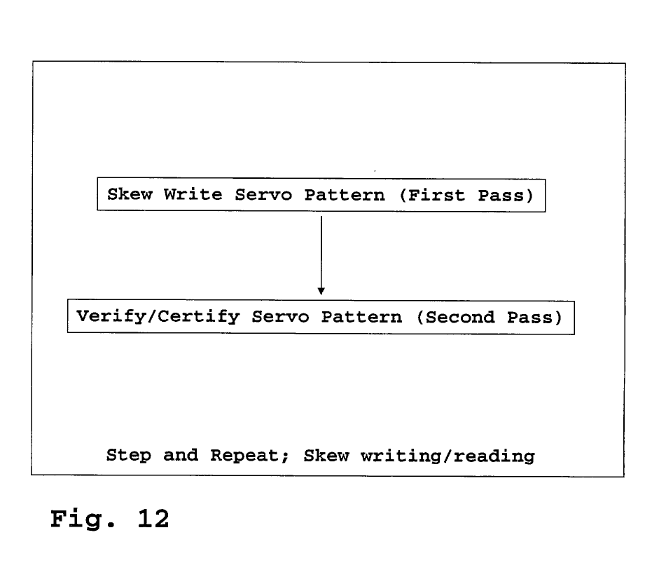

According to a sixth aspect of the current invention, the system skews each servo burst relative to all other disk surfaces in a multi disk arrangement. This skewing separates the servo patterns in time such that only a single servo pattern is being read from any disk at any one time during operation. Use of this skewing arrangement enables use of a single servo verification circuit to certify surfaces using a single revolution. Thus the system performs two passes in this sixth aspect of the invention, a first pass over all surfaces to write servo data in a skewed pattern, and a second pass to verify servo data and certify the disk surface. This sixth aspect of the current invention requires individual read enable hardware for each media certifier, and servo patterns must not be skewed across disks, or more complex hardware will be required to control when the certifier hardware is enabled, and rout the servo pattern to the proper head when writing while writing an F pattern to all other heads. FIG. 12 illustrates the various blocks of this sixth aspect of the current system.

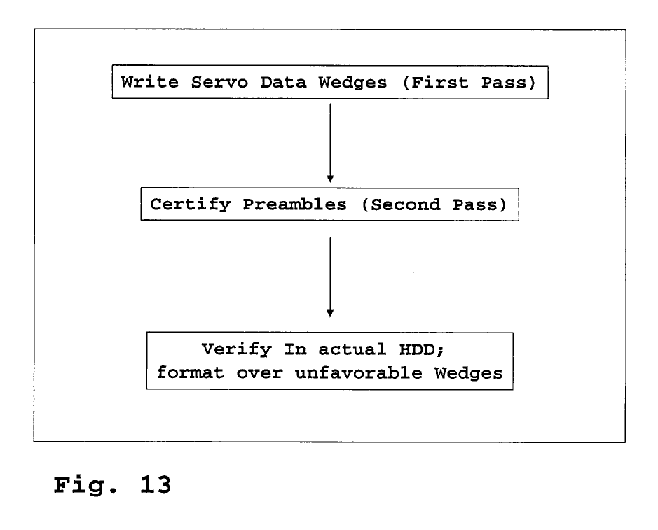

According to a seventh aspect of the current invention, the system writes multiple sets of servo data wedges over the entire surface of the disk. Certification is done on the preambles of the servo wedges to cull unacceptable disks. The disk drive is then used to verify the servo patterns and selects the best servo pattern from those available. During formatting of the hard drive, the drive overwrites all unfavorable servo wedges. In this manner, servo verification occurs in the actual hard drive being used. FIG. 13 illustrates the various blocks of this seventh aspect of the current system.

One of ordinary skill in the servowriting and certification art will realize that the various aspects discussed herein may be used in combination with other aspects and/or in different ordering from that specifically enumerated while still within the course and scope of the current invention.

While the invention has been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

What is claimed is:

1. A method for performing a joint certification and servowriting function on a plurality of media, comprising:
writing a predetermined certification and servo pattern to a plurality of disks, said predetermined certification and servo pattern comprising servo data;
reading said predetermined certification and servo pattern to ascertain parametric performance of said plurality of media.

2. The method of claim 1, wherein said certification and servo pattern comprises a coherent pattern in combination with a servo pattern.

3. The method of claim 1, wherein said certification and servo pattern comprises a servo pattern.

4. The method of claim 1, wherein said writing comprises writing certification data on a first pass and writing servo data on a second pass.

5. The method of claim 4, wherein said reading comprises reading certification data and servo data on a third pass.

6. The method of claim 1, wherein said reading and writing comprises performing a step and repeat function.

7. The method of claim 1, wherein said reading and writing comprises performing a spiral function.

8. The method of claim 7, wherein use of said spiral function requires use of a plurality of positioners.

9. The method of claim 1, wherein writing comprises writing a coherent pattern, and reading comprises reading a preamble section of a servo pattern written to each media.

10. The method of claim 1, wherein said writing comprises writing servo data in a relative skewed manner, said relative skewed manner comprising writing servo data to a first media at a predetermined physical position thereon, and writing servo data to subsequent media at individually skewed physical positions such that no alignment exists between the written servo data on all media.

11. A system for performing combined certification and servowriting for a plurality of media, comprising:
a media holder for holding said plurality of media;
a positioner comprising multiple arms having a head affixed to each arm; and
a controller for controlling data written to and read from said media, said controller enabling writing of a predetermined certification and servo pattern comprising servo data to said media; and further enabling reading said predetermined certification and servo pattern to ascertain performance of said plurality of media.

12. The system of claim 11, wherein said certification and servo pattern comprises a coherent pattern in combination with a servo pattern.

13. The system of claim 11, wherein said certification and servo pattern comprises a servo pattern.

14. The system of claim 11, wherein said writing comprises writing certification data on a first pass and writing servo data on a second pass.

15. The system of claim 14, wherein said reading comprises reading certification data and servo data on a third pass.

16. The system of claim 11, wherein said reading and writing comprises performing a step and repeat function.

17. The system of claim 11, wherein said reading and writing comprises performing a spiral function.

18. The system of claim 17, further comprising at least one additional positioner for use in reading and writing said certification and servo data using the spiral function.

19. The system of claim 11, wherein writing comprises writing a coherent pattern, and reading comprises reading a preamble section of a servo pattern written to each media.

20. The system of claim 11, wherein said writing comprises writing servo data in a relative skewed manner, said relative skewed manner comprising writing servo data to a first media at a predetermined physical position thereon, and writing servo data to subsequent media at individually skewed physical positions such that no alignment exists between the written servo data on all media.

21. The system of claim 11, wherein said heads comprise custom write heads.

22. A method for certifying a plurality of media in combination with writing servo data to said media, comprising:
writing data to said plurality of media, said data comprising at least one from a group including parametric test data and defect testing data, and said data further comprising servo data; and
reading said data to ascertain parametric performance of said plurality of media.

23. The method of claim 22, wherein said data comprises a coherent pattern in combination with a servo pattern.

24. The method of claim 22, wherein said data comprises a servo pattern.

25. The method of claim 22, wherein said writing comprises writing certification data on a first pass and writing servo data on a second pass.

26. The method of claim 25, wherein said reading comprises reading certification data and servo data on a third pass.

27. The method of claim 22, wherein said reading and writing comprises performing a step and repeat function.

28. The method of claim 3, wherein said reading and writing comprises performing a spiral function.

29. The method of claim 28, wherein use of said spiral function requires use of a plurality of positioners.

30. The method of claim 22, wherein writing comprises writing a coherent pattern, and reading comprises reading a preamble section of a servo pattern written to each media.

31. The method of claim 22, wherein said writing comprises writing servo data in a relative skewed manner, said relative skewed manner comprising writing servo data to a first media at a predetermined physical position thereon, and writing servo data to subsequent media at individually skewed physical positions such that no alignment exists between the written servo data on all media.

32. A system for performing combined certification and servowriting for a plurality of media, comprising:
means for writing data to said plurality of media, said data comprising at least one from a group including parametric test data and defect testing data, and said data further comprising servo data; and
means for reading said data to ascertain parametric performance of said plurality of media.

33. The system of claim 32, wherein said certification and servo pattern comprises a coherent pattern in combination with a servo pattern.

34. The system of claim 32, wherein said certification and servo pattern comprises a servo pattern.

35. The system of claim 32, wherein said writing comprises writing certification data on a first pass and writing servo data on a second pass.

36. The system of claim 35, wherein said reading comprises reading certification data and servo data on a third pass.

37. The system of claim 32, wherein said reading and writing comprises performing a step and repeat function.

38. The system of claim 32, wherein said reading and writing comprises performing a spiral function.

39. The system of claim 38, wherein use of said spiral function requires use of a plurality of positioners.

40. The system of claim 32, wherein writing comprises writing a coherent pattern, and reading comprises reading a preamble section of a servo pattern written to each media.

41. The system of claim 32, wherein said writing comprises writing servo data in a relative skewed manner, said relative skewed manner comprising writing servo data to a first media at a predetermined physical position thereon, and writing servo data to subsequent media at individually skewed physical positions such that no alignment exists between the written servo data on all media.

42. The system of claim 32, further comprising a plurality of heads performing said reading and writing, and wherein said heads comprise custom write heads.
